(19) United States
(12) Patent Application Publication
(10) Pub. No.: US 2021/0025541 A1
(43) Pub. Date: Jan. 28, 2021

(54) Stand for suitable objects and apparatus

(71) Applicant: Clarence Wheeler, Atlanta, GA (US)

(72) Inventor: Clarence Wheeler, Atlanta, GA (US)

(73) Assignee: Nurosphere Inc., Atlanta, GA (US)

(21) Appl. No.: 15/930,810

(22) Filed: Aug. 20, 2020

(51) Int. Cl. F16M 11/38; F16C 11/00

(52) U.S. Cl. CPC F16M 11/38; F16C 11/00

(57) ABSTRACT

A stand for suitable objects. The stand is configured to allow a object to be mounted and unmounted allowing stability to hold the object in an up right position. The said may be made of a lightweight material such as steel, stainless steel, metal or aluminum which may be inexpensive to manufacture.

### CROSS-REFERENCE TO RELATED APPLICATION

Not Applicable.

### STATEMENT REGARDING FEDERALLY SPONSORSHIP RESEARCH OR DEVELOPMENT

Not Applicable.

### MICROFICHE APPENDIX

Not Applicable.

### BACKGROUND OF INVENTION

### Field of the Invention

The purpose invention in general relates to a stand configured to capable of supporting suitable objects.

### BRIEF SUMMARY OF THE INVENTION

The subject invention comprises a stand for easily mounting a suitable object or apparatus onto. The present invention may include one or more legs, stanchion(s) and one or more object mounting components. The leg(s) portion may include an top portion and bottom portion coupled to an portion of the stanchion(s). The invention comprises an U-joint that allows an portion of the leg(s) to pivot inward and outward. Furthermore, the invention comprises at lease one object mounting component that allows an object to couple to an portion of the stand.

### BRIEF DESCRIPTION OF SEVERAL VIEWS OF THE DRAWINGS

These and other features and advantages of the present invention will better become understood by reference to the following detailed description when considered in connection with the accompanying embodiment(s), wherein,

FIG. 1A-1B is a perspective view, illustrating the present invention.

FIG. 2 is an perspective view, illustrating an portion of the stand rod(s) according to one embodiment of the present invention.

FIG. 3A-3B is an perspective view, illustrating the top and bottom leg(s) portion according to another embodiment of the present invention.

FIG. 4 is a schematic diagram of the spider member according to one embodiment of the present invention.

FIG. 5 is an perspective view, illustrating the rod(s) sliding component according to one embodiment of the present invention.

### DETAIL DESCRIPTION OF THE PREFERRED EMBODIMENT(S)

Referring to the figures, wherein like numerals indicate like or corresponding parts throughout the several views, an exemplary object is generally shown at 3 mounted onto the stand 1. For purpose of illustration and not to be in anyway limiting, the following description will make reference to the object 3 mounted onto the stand 1. However, it will be appreciated that the invention is equally applicable to support the weight, and maintain stability for securing a object 3 of all shape and sizes which may be mounted onto the stand 1.

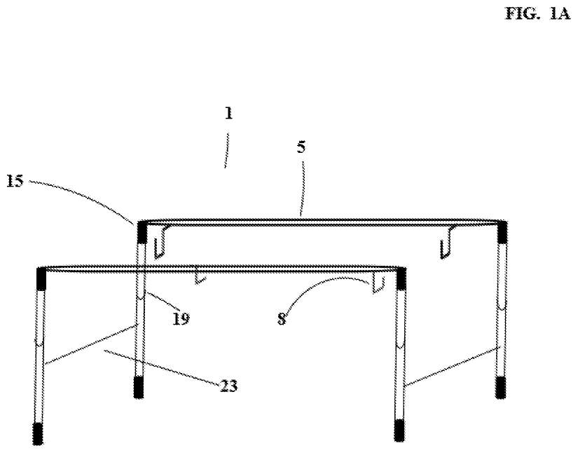

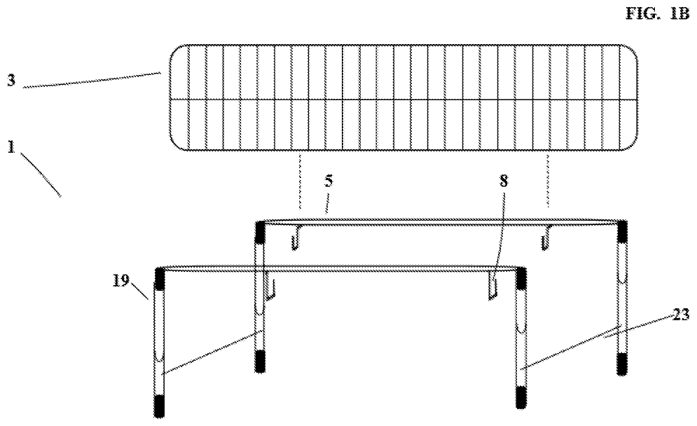

Referring to FIG. 1A-1B, shown is a stand 1 in an assembled state, the stand 1 may comprise one or more vertical legs 19 adjacent each configured to provide a stable foundation for supporting the stand 1 when at a up-right position. Further, showing one or more stanchion(s) 5 coupled to one or more components of the present invention and one or more object mounting component(s) 8 coupled to an area of the one or more stanchion(s) 5. The one or more object mounting component(s) 8 is further configured to allocate one or more objects 3 to assemble on the stand 1 FIG. 1B. The stand 1 also comprises one or more stems 23 for coupling the one or more leg(s) 19 to an opposing leg(s) 19.

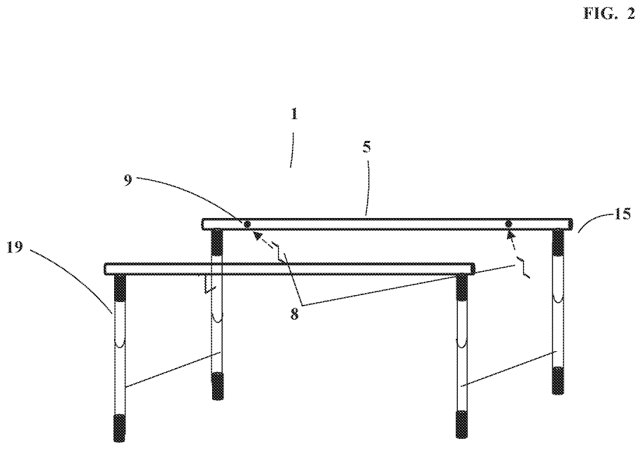

According to FIG. 2 shows an illustration of the one or more stanchion(s) 5. The present invention comprises a left and right stanchion(s) 5 coupled to one or more components of the stand 1. The one or more stanchion(s) 5 consist of an tubular-shape comprising one or more threaded opening(s) 9 at one or more areas of its body that allocate the one or more object mounting components 8 to couple to a area of its body. In motion to coupling one or more objects 3 to stand 1 the object mounting component 8 also comprises a threaded area at one end configured to introduce within the one or more threaded openings 9. The one or more stanchion(s) 5 also comprises opening 15 extending from its body consisting of an threaded region (interior) that allocates the one or more stanchion(s) 5 to couple to leg(s) 19.

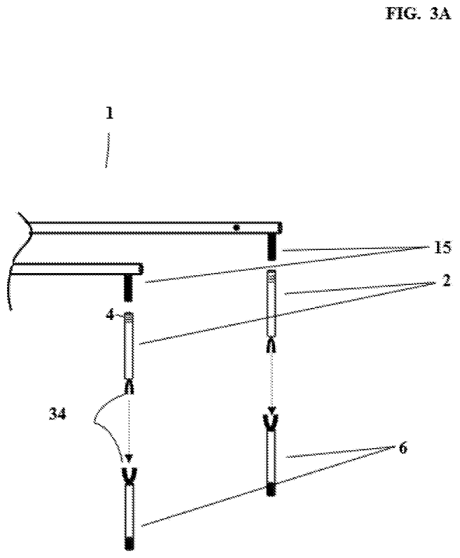

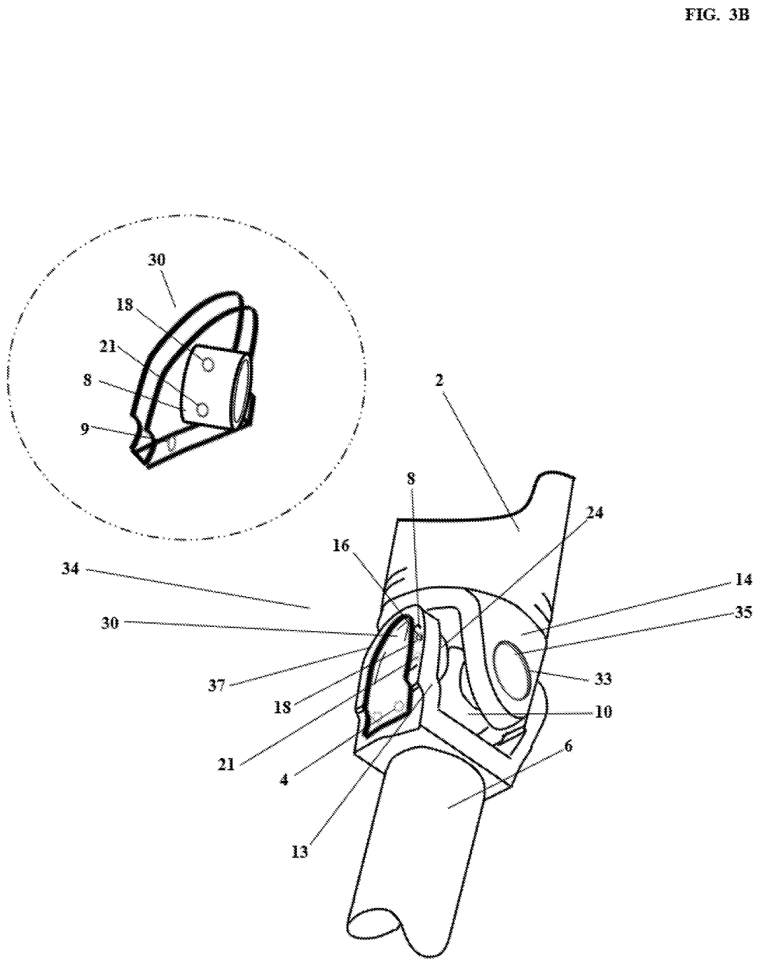

According to FIG. 3A-3B shows an illustration of the one or more leg(s) 19 and stanchion(s) 5 as mentioned above in FIG. 1A-1B, stand 1 comprises a left and right vertical leg 19 adjacent each other at each side of stand 1.

Specifically, left and right legs 19 consists of a top leg and bottom leg portion 2, 6, forming a cylinder shape single structure. Further, a top area of the top legs portion 6 comprises a threaded area 4 (e.g., exterior) respectively coupled to the opening 15. However, top leg portion 2 and bottom leg portion 6 are coupled together therefore via top leg portion 2 yoke 14 and bottom leg portion 6 yoke 13 forming U-joint 34.

The U-joint 34 comprises a yoke 14 connected to leg 19 and a yoke 13 connected to opposing leg 19. The one or more yokes 14 and 13 are better understood by being respectively rotated by 90 degrees relative to each other. The yoke 13 includes one or more threaded opening(s) 9 on its side surface configured to receive one or more screw(s) 4 for coupling retainer(s) 30 to yoke 13. One or more X-shaped spider member 10 respectively coupling yokes 14 and 13. The one more spider member(s) 10 comprises one or more trunnions 24 that projects into seal(s) 33 disposed within apertures 35 in yokes 13 and 14. Note when spider member(s) 10 is disposed within apertures 35 end region slightly project outwardly towards surface 37 disposed within opening 8. The one or more seal(s) 33 may comprises a plurality or grooves or rollers which allocates a portion of the one or more trunnions 24 to bear against.

Moreover, to construct leg(s) 19 U-joint 34 the one or more seal(s) 33 disposed inwardly from the exterior of the one or more yokes 13 and 14 into the one or more apertures 35. When this is preformed seal(s) 33 cover trunnions 24 but space is provided to allocate the one or more trunnions 24 to rotate within apertures 35 when the stanchion(s) 5 is adjusted inward or outward.

When seal(s) 33 is disposed over the one or more trunnion(s) 24 they are held in place by retainers 30. The one or more retainer(s) 30 further includes circular opening 8 protruding from its body configured to receive end region of trunnion(s) 24 projecting from apertures 35 and is constructed to allow top leg portion 6 to pivot in motion laterally in response to a user action with the one or more stanchion(s) 5.

Specifically, circular opening 8 further includes one or more means for allocating pivoting the top leg portions 2. Specifically, circular opening 8 composes a first opening 18 formed on a top area and a second opening 21 formed on a side area for receiving drive protrusion 16 in response to coupling end region of trunnion(s) 24 to circular opening 8.

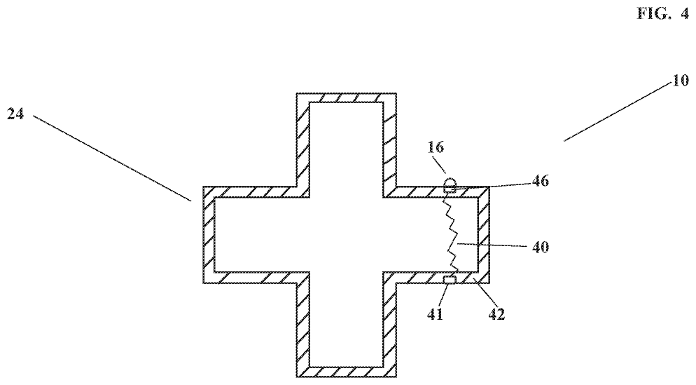

FIG. 4 illustrates a schematic diagram spider member 10 according to the present invention. Spider member 10 comprises a generally X-shaped having one or more trunnion(s) 24 extending from it's body through apertures coupled to circular opening. Spider member 10 also includes one or more drive protrusions 16 protruding from opening and at top surface of the one or more trunnion(s) 24 configured to lock top leg portion(s), this also permits the one or more top leg portion(s) to pivot laterally when drive protrusion(s) 16 is pushed down and stanchion(s) is adjusted inward or outward.

As mentioned above, spider member 10 comprises a X-shaped having one or more trunnion(s) 24 having one or more drive protrusions 16 disposed at a top surface of trunnion(s) 24. To accomplish this, trunnion(s) 24 comprises opening 41 projecting from inner surface 42, opening 41 is configured to receive coil spring 40. The manufacture may install coil spring 40 at the time spider member 10 is made, coil spring 40 may be a slight larger than opening 41, this may take a slight force in order to insert spring coil 40 into opening 41. When coil spring 40 is disposed within opening 41 coil spring 40 extends to opening 46 towards outer surface, drive protrusion 16 is coupled to end region of coil spring 40.

Specifically, drive protrusion 16 forms a circular shape (e.g., button) having a opening 41 at lower surface to receive coil spring 40. Opening 41 formed at lower region of drive protrusion 16 is constructed such that when coil spring 40 is disposed within opening 41 a tight fit presented and coil spring 40 is locked within opening 41. Opening 41 may comprises a grove region or other suitable member that ensures coil spring 40 locks in place. The manufacture may install coil spring 40 at the time spider member 10 is made this may take a slight force in order to insert spring coil 40 into opening 41.

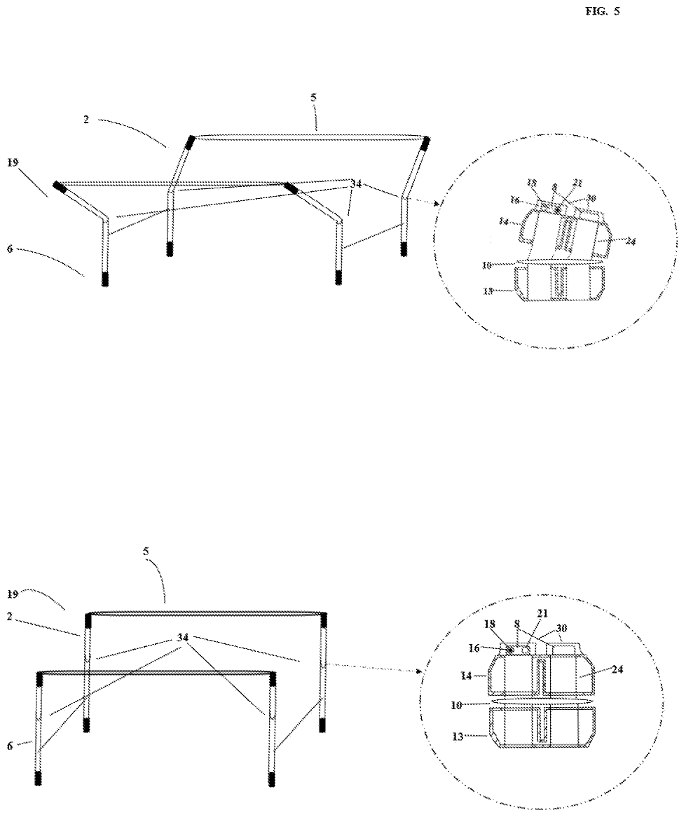

FIG. 5 is a illustration of the stand 1 in use with the one or more legs 19 and the u-joint 34 pivoted. The one or more leg(s) 19 is conducive to pivoting outward laterally in response to adjustment of stanchion(s) 5 in accordance with the present invention.

In a preferred design, the one or more leg(s) 19 comprises top leg portion 2 coupled to bottom leg portion 6 as shown in FIG. 3, configured to pivot laterally during adjustment of stanchion(s) 5 and locked in place when adjusted. However, when drive protrusion 16 are pushed through first opening 18 and stanchion(s) 5 is adjust outwardly top leg portion 2 is pivoted and drive protrusion 16 is projected out therefrom second opening 21 and top leg portion 2 is locked in place. Preferably, the drive protrusion 16 are positioned to project from a top side of opening 8 facing side of stand 1. Further, when stand 1 is adjusted back to its original position drive protrusion 16 is pushed through second opening 21 and stanchion(s) 5 is adjusted inward top leg portion 2 is pivoted and drive protrusion 16 is projected out therefrom first opening 18 and top leg portion 2 is locked in place. However, when the user presses drive protrusion 16 a small utensil may be required to access spacing in-between retainer 30 and yoke.

The present invention has been described in an illustrative manner, and it is to be understood that the following terminology which has been used is intended to be in the nature of words of description rather than of limitation. Obviously, many modifications and variations of the present invention are possible in the light of the above teachings. It is therefore, to be understood that within the scope of the appended claim, the invention may be practiced otherwise than as specially described. The invention is defined by the claim.

1-2. (canceled)

3: A stand comprising:
a spider member;
a top leg portion and a bottom leg portion, and wherein the top leg portion and bottom leg portion includes a means for coupling to one another forming a single leg structure;
a retainer coupled to a yoke having a opening extending from a body, and wherein the opening comprises a first and second opening configured to lock a top leg portion at a predetermine position in response to a user pushing a drive protrusion and adjusting a stanchion(s) at a predetermine direction;

4: The stand according to claim 3, wherein said cross member comprises a trunnion(s) having a opening projecting from inner surface configured to receive a coil spring; and when said coil spring is disposed within the opening said coil spring extends to the opening towards a outer surface and said drive protrusion is coupled to end side of the coil spring.

5: The stand according to claim 3, wherein the top leg portion and bottom leg portion comprises a yoke, and wherein the spider member is disposed intermediate the yoke forming the single leg structure.

6: The stand according to claim 3, further comprising the top leg portion is coupled the stanchion(s).

7: The stand according to claim 3, further comprising the retainer is coupled to the bottom leg portion yoke.

8: The stand according to claim 3, when a drive protrusion is pushed in and said stanchion(s) is adjusted outward said drive protrusion is projected from the first opening to the second opening and the top leg portion is at a 90 angle position; and when said drive protrusion is pushed in and said stanchion(s) is adjusted inward said drive protrusion is projected from said second opening to said first opening and top leg portion is at a upright position.

9: The stand according to claim 3, further comprising the drive protrusion is formed on one of the trunnion(s).
